(19) United States
(12) Patent Application Publication
(10) Pub. No.: US 2026/0233635 A1
(43) Pub. Date: Aug. 13, 2026

(54) Systems and Methods Associated with Dynamic Thermal and Pressure Control of a Battery

(71) Applicant: Supernal, LLC, Irvine, CA (US)

(72) Inventors: William Tai, Hayward, CA (US); Soundararajan Manthiri, Cupertino, CA (US); Tuan Tran, Sunnyvale, CA (US)

(21) Appl. No.: 19/155,745

(22) PCT Filed: Feb. 15, 2024
(86) PCT No.: PCT/US2024/016053

§ 371 Date: Aug. 12, 2025

Related U.S. Application Data
(60) Provisional application No. 63/446,793, filed on Feb. 17, 2023.

(51) Int. Cl. B60L 58/26; H01M 10/613; H01M 10/617; H01M 10/625; H01M 10/63; H01M 10/6552; H01M 10/6567; H01M 50/249

(52) U.S. Cl. CPC B60L 58/26; H01M 10/613; H01M 10/617; H01M 10/625; H01M 10/63; H01M 10/6552; H01M 10/6567; H01M 50/249; H01M 2200/20; H01M 2220/20

(57) ABSTRACT

An example embodiment includes a battery having a plurality of battery modules, each battery module comprising a plurality of battery cells; a pressure control system configured to provide fluid having a target fluid pressure that achieves a target pressure to be applied to respective battery cells of a battery module; and a thermal control system configured to supply coolant to the battery module to achieve a target temperature.

### CROSS REFERENCE TO RELATED APPLICATION

The present application claims priority to U.S. Provisional Patent Application No. 63/446,793, filed on Feb. 17, 2023, the entire contents of which are herein incorporated by reference as if fully set forth in this description.

### BACKGROUND

Batteries are used in many applications including consumer electronics, electric vehicles, robots, and power-grid storage. A battery goes through many cycles of charging and discharging throughout its life.

An example battery includes several battery modules, each battery module having a respective plurality of battery cells. The battery may heat up during charging, and particularly during fast charging rates (e.g., high coulomb rates). Further, during periods of high demand on the battery, the battery may heat up substantially.

High temperatures reduce the lifespan of the battery, and may lead to an increase in the risk of a thermal runaway event (e.g., an event where a strong exothermic chain reaction occurs within a battery cell, and the battery cell enters an uncontrollable, self-heating state that could result in ejection of gas, shrapnel, and/or particulates). It may thus be desirable to cool the battery to reduce the temperature of the battery (e.g., during fast charging or when demand on the battery is high). Cooling during charging may increase the efficiency of charge transfer and reduce degradation of the battery, allowing the battery to retain capacity over its lifetime.

In some cases, it may be desirable to operate a battery above a particular temperature, thereby optimizing performance of the battery. In these cases, it may be desirable to warm the battery to the particular temperature. As such, it may be desirable to have a thermal control system that maintains the battery within a desired temperature range.

A conventional thermal control system of a battery may control the temperature of the battery as a whole (e.g., operating all the battery modules at the same temperature). In a conventional battery pack thermal system, however, the coolant flow is in series, so the battery modules and cells that are closer to the coolant inlet of the battery tend to be cooler than the modules and cells that are further from the coolant inlet. It may thus be desirable to have a battery thermal control system capable of independently controlling respective temperatures of individual battery modules. This way, the temperature across all the modules can rise or fall more evenly, for example.

Further, in some cases, batteries may have low mechanical stability. For instance, a battery may expand during operation (e.g., during high charge or discharge rate operations), which could lead to failures (e.g., a thermal runaway event or toxic gas release). As such, optimizing battery performance may be desirable to avoid such failures. It may thus be desirable to apply pressure on battery packs to maintain their stability and enhance their performance. It is with respect to these and other considerations that the disclosure made herein is presented.

### SUMMARY

The present disclosure describes implementations that relate to systems and methods associated with dynamic thermal and pressure control of a battery.

In a first example implementation, the present disclosure describes a thermal control system for a battery having a plurality of battery modules. The thermal control system includes: a coolant supply system configured to supply hot coolant and cold coolant; a thermal management control module configured to set a target temperature for each battery module of the battery; and a plurality of temperature control units, each temperature control unit configured to control a temperature of a respective battery module independently from other battery modules of the battery, wherein a temperature control unit of the plurality of temperature control units comprises (i) one or more valves, and (ii) a valve control unit configured to control actuation of the one or more valves based on an actual temperature and the target temperature of the respective battery module. The one or more valves are configured to control flow of the hot coolant and the cold coolant received from the coolant supply system, and wherein the temperature control unit is configured to supply a mixture of the hot coolant and the cold coolant to the respective battery module to achieve the target temperature.

In a second example implementation, the present disclosure describes a pressure control system. The pressure control system includes: a battery having a plurality of battery modules, each battery module comprising a plurality of battery cells; a fluid supply system; a pressure management control module configured to set a target pressure to be applied to respective battery cells of each battery module of the battery via fluid from the fluid supply system; and a plurality of pressure control units, each pressure control unit configured to control pressure applied to the respective battery cells of a respective battery module independently from other battery modules of the battery, wherein a pressure control unit of the plurality of pressure control units comprises (i) a pressure control valve, and (ii) a valve control unit configured to control actuation of the pressure control valve to provide fluid having a target fluid pressure that achieves the target pressure to be applied to the respective battery cells.

In a third example implementation, the present disclosure describes a vehicle. The vehicle includes the thermal control system of the first example implementation and the pressure control system of the second example implementation. The vehicle includes a fluid supply system configured to provide fluid to the pressure control system and coolant to the thermal control system.

The foregoing summary is illustrative only and is not intended to be in any way limiting. In addition to the illustrative aspects, implementations, and features described above, further aspects, implementations, and features will become apparent by reference to the drawings and the following detailed description.

### BRIEF DESCRIPTION OF THE FIGURES

FIG. 1 is a block diagram of a vehicle, according to exemplary embodiments of the present invention.

FIG. 2 is a block diagram of a system for thermal and pressure control of a battery, according to exemplary embodiments of the present invention.

FIG. 3 is a block diagram of another system for thermal and pressure control of a battery, according to exemplary embodiments of the present invention.

FIG. 4 is a block diagram showing a thermal control system, according to exemplary embodiments of the present invention.

FIG. 5 is a block diagram showing a coolant supply system, according to exemplary embodiments of the present invention.

FIG. 6 is a block diagram showing another coolant supply system, according to exemplary embodiments of the present invention.

FIG. 7 is a block diagram showing a thermal control unit, according to exemplary embodiments of the present invention.

FIG. 8 is a block diagram showing another thermal control unit, according to exemplary embodiments of the present invention.

FIG. 9 is a block diagram of a diagnostic module, according to exemplary embodiments of the present invention.

FIG. 10 is a block diagram for a pressure control system, according to exemplary embodiments of the present invention.

FIG. 11 is a block diagram showing a fluid supply system, according to exemplary embodiments of the present invention.

FIG. 12 is a block diagram showing another fluid supply system, according to exemplary embodiments of the present invention.

FIG. 13 is a block diagram of a pressure control unit, according to exemplary embodiments of the present invention.

FIG. 14 illustrates a pressure mechanism configuration for applying pressure to individual battery cells, according to exemplary embodiments of the present invention.

FIG. 15 illustrates a pressure mechanism configuration for applying the same pressure to battery cells of a battery module, according to exemplary embodiments of the present invention.

FIG. 16 illustrates another pressure mechanism configuration for applying pressure to battery cells of a battery module, according to exemplary embodiments of the present invention.

### DETAILED DESCRIPTION

Disclosed herein are systems and methods for thermal and pressure control of batteries. The disclosed systems and methods are applicable to any type of battery (e.g., lithium-ion batteries, batteries having silicon-alloy/graphite blend anode combined with a nickel rich lithium nickel manganese cobalt oxide as cathode, lithium metal batteries, etc.).

The disclosed system may be utilized in any device or application that uses batteries. For example, the batteries may be used to power electric motors of a vehicle, including but not limited to a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, a vertical take-off and landing (VTOL) craft, or a drone). The disclosed embodiments of the present invention may be used in any of these applications in order to obtain advantages such as operating individual battery modules at respective desired temperatures, reducing the likelihood of a thermal runaway event, enhancing battery capacity, reducing internal Ohmic resistance of the battery over its life, reducing capacity degradation over the life of the battery, and maintaining robust packaging of the battery.

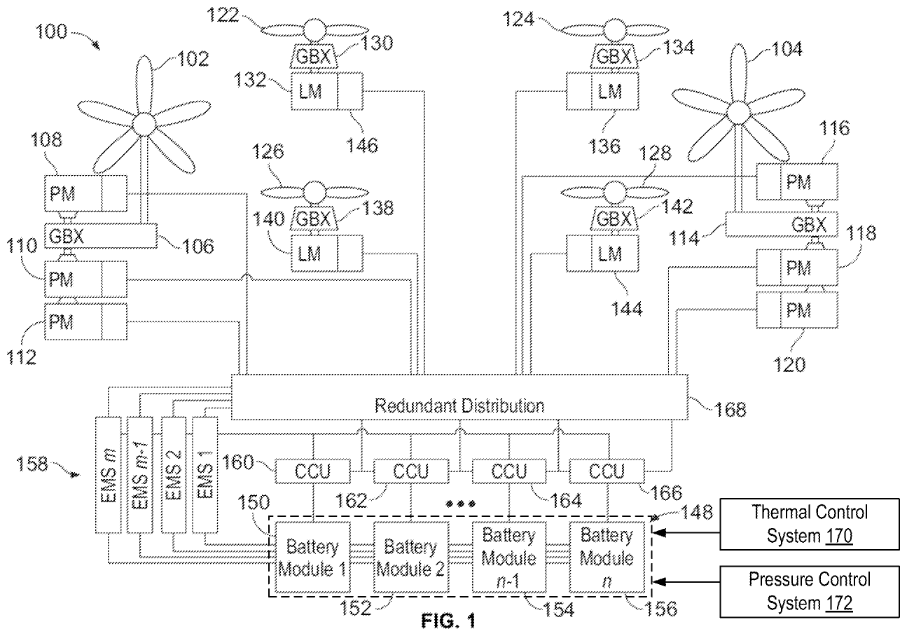

FIG. 1 is a block diagram of a vehicle 100, according to an exemplary embodiment of the present invention. In some embodiments, and as noted above, the vehicle 100 may be a VTOL, which may use electric power to hover, takeoff, and/or land. It should be understood that in other embodiments, the vehicle 100 may be any other type of vehicle that may be able to utilize the advantages of the present invention, such as a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, or a drone).

In some embodiments, the vehicle 100 may include one or more propellers and rotors used to drive the vehicle, such as propellers 102, 104 and lift rotors 122, 124, 126, and 128 illustrated in FIG. 1. Each propeller may be configured, for example, as a tiltrotor, a lift rotor, or any other type of rotor. In other embodiments, the vehicle 100 may include one or more turbine engines, one or more tires, one or more ski-structures, or the like instead of the one or more propellers used to drive the vehicle.

The first propeller 102 may be driven by a gearbox 106, which in turn is driven by one or more motors such as propeller motor 108, propeller motor 110, and propeller motor 112. Similarly, the second propeller 104 is driven by a gearbox 114, which in turn is driven by one or more motors such as propeller motor 116, propeller motor 118, and propeller motor 120. In some embodiments, the motors may be electric motors.

The vehicle 100 also may include multiple lift rotors, such as multiple lift rotors that can facilitate vertical takeoff and landing of the vehicle 100. For example, the vehicle 100 can include a lift rotor 122, a lift rotor 124, a lift rotor 126, and a lift rotor 128.

The lift rotor 122 is driven by a gearbox 130, which in turn is driven by a motor 132. The lift rotor 124 is driven by a gearbox 134, which in turn is driven by a motor 136. The lift rotor 126 is driven by a gearbox 138, which in turn is driven by a motor 140. The lift rotor 128 is driven by a gearbox 142, which in turn is driven by a motor 144.

In one embodiment, each of the motors described above may include one or more respective motor controllers integrated therewith. For example, the lift motor 132 has one or more motor controllers 146 integrated therewith.

In some embodiments, the various motors of the vehicle 100 may be electric motors driven by electric power provided by a battery 148 having a plurality of battery modules. As depicted in in FIG. 1, the battery 148 can have “n” battery modules, such as battery module 150, battery module 152, battery module 154, and battery module 156. Each battery module can include a housing or enclosure that houses a plurality of battery cells arranged in rows and/or columns.

The battery 148 is configured to store electric power, and provide electric power to the various electric motors when commanded by respective energy management systems of the vehicle 100. Particularly, in an example implementation, the vehicle 100 can have a plurality (“m”) of energy management systems (EMSs) 158 that are in communication with the battery modules 150-156. The EMSs 158 are configured as electronic regulators that monitor and control the charging and discharging of the battery modules 150-156.

In an example, the EMSs 158 are configured to measure voltages of the battery modules 150-156 and stop charging them when a desired voltage is reached. The EMSs 158 can also monitor and control parameters of the battery modules 150-156. For example, the EMSs 158 monitor and control main power voltage, battery or cell voltage, charging and discharge rates of the battery modules 150-156, etc.

The vehicle 100 may further include multiple contactor control units (CCUs), such as CCU 160, CCU 162, CCU 164, and CCU 166, which are electrically coupled to the battery modules 150-156, and are in communication with the EMSs 158. In one embodiment, as illustrated in FIG. 1, each CCU is coupled to a respective battery module of the battery modules 150-156. A contactor is an electrically-controlled switch used for switching an electrical power circuit. A CCU may control the actuation of the contactor to allow power flow to and from the respective battery module. For example, the EMSs 158 control the power flow to and from the battery modules 150-156 based on power demand from the various electric motors, and accordingly control the CCUs to enable power flow from particular battery modules as desired.

The vehicle 100 may be configured to include a distributed electric propulsion system configured to provide the vehicle 100 with energy to power the multiple propellers and lift rotors via an electric transmission system. Particularly, the vehicle 100 can include a redundant distribution module 168 in communication with the EMSs 158, and the redundant distribution module 168 is electrically coupled to the battery modules 150-156 via the respective CCUs 160-166, and is configured to provide electric power, via transmission lines, to the multiple electric motors of the vehicle 100.

The EMSs 158 along with the redundant distribution module 168 can provide for redundancy in the vehicle 100 such that if, for example, one propeller or one lift rotor fails, power can be distributed to other propellers or lift rotors to maintain operation of the vehicle 100.

The vehicle 100 may further include a thermal control system 170. As described in more detail below, the thermal control system 170 is configured to control temperature level of each battery module of the battery 148 to maintain safe and enhanced operation of the battery 148. Safe operation may include, as examples, controlling the temperature of each battery module to be below a first threshold temperature and above a second threshold temperature (i.e., within a target temperature range) to increase the lifespan of the battery module, preclude overheating, preclude failure of the battery modules, etc.

Different battery modules can be operated at different temperature ranges independently as desired. Further, the temperature range can be changed dynamically during operation of a respective battery module based on changes in environmental and internal conditions of the battery module.

The vehicle 100 may also include a pressure control system 172. As described in more detail below, the pressure control system 172 may be configured to apply pressure to battery cells of a battery module to enhance the capacity of the battery 148, reduce internal Ohmic resistance of each battery module/cell, increase efficiency of each battery module, etc. In examples, the pressure control system 172 can apply a respective pressure to each battery module that is different from pressure applied to other battery modules. In some examples, the pressure control system 172 can apply a respective pressure to each battery cell of a battery module that is different from pressure applied to other battery cells of the battery module. Further, the pressure level can be changed dynamically during operation of a respective battery module/cell based on changes in environmental and internal conditions of the battery module/cell.

In example embodiments, the thermal control system 170 and the pressure control system 172 may be included in, or may be in communication with, the EMSs 158. Further, in example embodiments, the thermal control system 170 and the pressure control system 172 may share components (e.g., may share a fluid supply system and the fluid supplied therefrom).

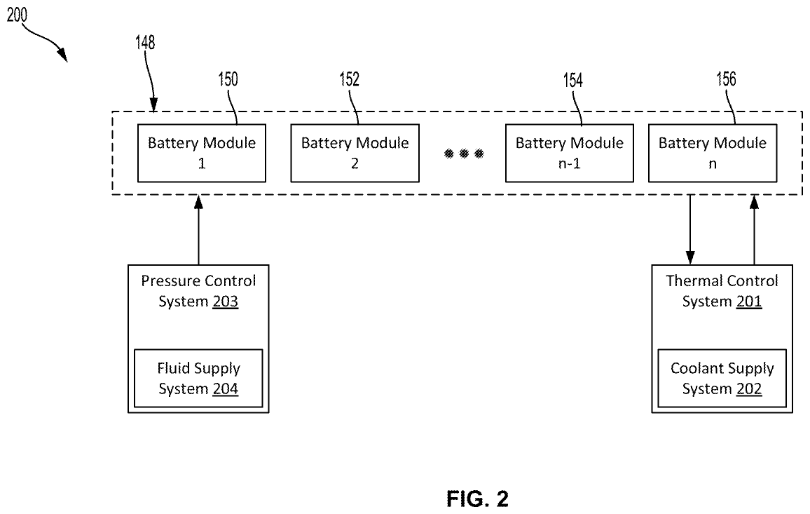

FIG. 2 is a block diagram of a system 200 for thermal and pressure control of the battery 148, according to example embodiments of the present invention. The system 200 may have a thermal control system 201 that includes a coolant supply system 202. The term “coolant” is used herein generally to indicate gas (e.g., air) or liquid (e.g., hydraulic fluid, water, ethylene glycol, etc.). The thermal control system 201 may represent the thermal control system 170, for example.

As described in more detailed below, the coolant supply system 202 may provide hot and/or cold coolant to other components of the thermal control system 201, which then controls coolant flow to the battery 148 and its respective battery modules individually to control respective temperatures of the battery modules.

The system 200 may also include a pressure control system 203 having a fluid supply system 204. The term “fluid” is used herein generally to indicate gas or liquid. The pressure control system 203 may represent the pressure control system 172, for example.

As described in more detailed below, the fluid supply system 204 may provide fluid to other components of the pressure control system 203, which then controls fluid flow to the respective battery modules individually to control pressure level applied to each battery module or its respective individual cells.

In some example embodiments, the thermal control system and the pressure control system can share a fluid supply system.

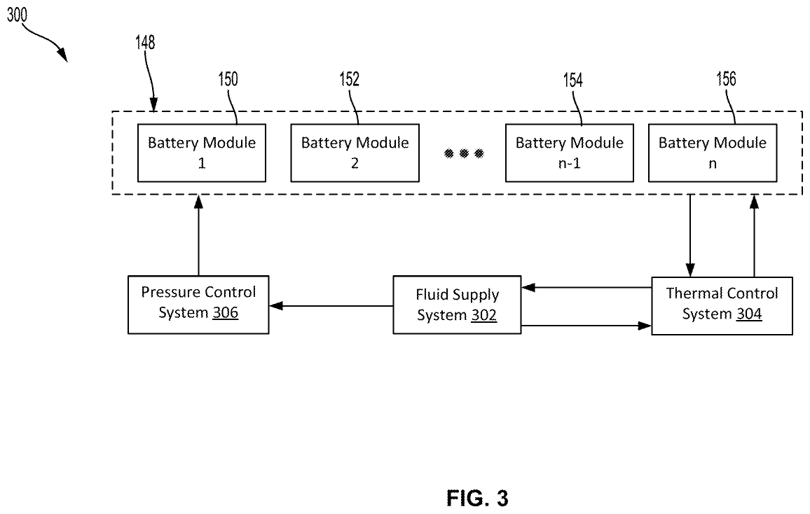

FIG. 3 is a block diagram of another system 300 for thermal and pressure control of the battery 148, according to example embodiments of the present invention. The system 300 may include a fluid supply system 302 that is configured to provide both coolant to a thermal control system 304 and fluid to a pressure control system 306. The thermal control system 304 may represent the thermal control system 170, for example. Also, the pressure control system 306 may represent the pressure control system 172, for example. With this configuration, the thermal control system 304 and the pressure control system 306 can share components of the fluid supply system 302 (e.g., fluid, pump or compressor, fluid reservoir, etc.).

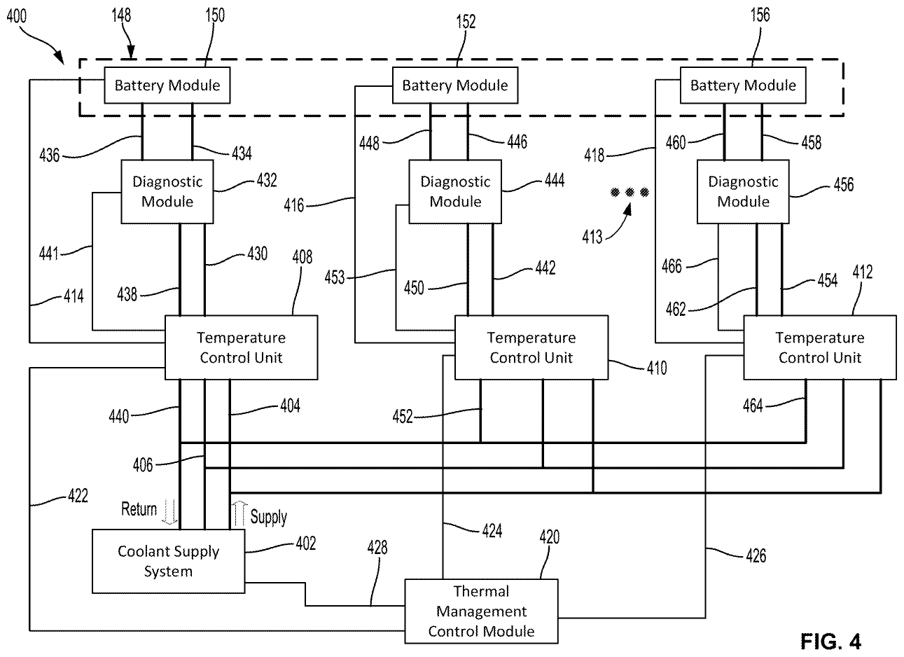

FIG. 4 is a block diagram showing a thermal control system 400, according to example embodiments of the present invention. The thermal control system 400 may represent any of the thermal control systems 170, 201, 304, for example.

The thermal control system 400 may include a coolant supply system 402. The coolant supply system 402 represents the coolant supply system 202 or the fluid supply system 302, for example. The coolant supply system 402 may be configured to provide hot coolant through hot fluid line 404 and cold coolant through cold fluid line 406. The term “fluid line” is used throughout the disclosure to encompass any fluid path such as a pipe, channel, tube, or hose, as examples.

Cold and hot coolants are supplied by the coolant supply system 402 to respective Temperature Control Units (TCUs) that control temperature level of the respective battery modules. For example, the thermal control system 400 includes TCU 408 configured to control temperature of the battery module 150, TCU 410 configured to control temperature of the battery module 152, and TCU 412 configured to control temperature of the battery module 156. Only three battery modules and three TCUs are shown, but it should be understood that any number of battery modules can be disposed in the battery 148 as represented by ellipses 413, and each battery module has a respective TCU that independently controls temperature level in the battery module.

Each TCU of the TCUs 408-412 receives temperature sensor information from a temperature sensor (e.g., a thermocouple) disposed within the respective battery module indicating a temperature of the battery module. For example, the TCU 408 receives temperature sensor information via a sensor signal line 414 from a temperature sensor within the battery module 150, the TCU 410 receives temperature sensor information via a sensor signal line 416 from a temperature sensor within the battery module 152, and the TCU 412 receives temperature sensor information via a sensor signal line 418 from a temperature sensor within the battery module 156.

The thermal control system 400 may also include a thermal management control module 420. The term “module” is used generally herein to include software, hardware, or a combination of software and hardware components. The thermal management control module 420 can include one or more processors along with a memory and programmable input/output peripherals. A processor can include a general purpose processor (e.g., a single core microprocessor or a multicore microprocessor), or a special purpose processor (e.g., a digital signal processor, a graphics processor, or an application specific integrated circuit (ASIC) processor). A processor can be configured to execute computer-readable program instructions (CRPI) to perform the operations described throughout herein. A processor can be configured to execute hard-coded functionality in addition to or as an alternative to software-coded functionality (e.g., via CRPI).

The thermal management control module 420 may be configured to set a respective desired or target temperature for each of the battery modules and provide such target temperature to the respective TCU. For example, the thermal management control module 420 provides a target temperature via a signal line 422 for the battery module 150 to the TCU 408, provides a target temperature via a signal line 424 for the battery module 152 to the TCU 410, and provides a target temperature via a signal line 426 for the battery module 156 to the TCU 412.

The thermal management control module 420 can also provide a command signal via a signal line 428 to the coolant supply system 402. The command signal may indicate to the coolant supply system 402 whether to supply coolant to the TCUs 408-412, and may also indicate the coolant flow rate to be supplied to the TCUs 408-412.

Each TCU of the TCUs 408-412 may control the amount of cold or hot coolant that flows to the respective battery module based on the target temperature set by the thermal management control module 420 and the actual temperature of the battery module. The coolant discharged from the TCU may then flow through a respective diagnostic module, which then provides coolant to the respective battery module to achieve the target temperature.

Particularly, in some example embodiments, the TCU 408 is configured to control mixture of hot coolant received via the hot fluid line 404 and cold coolant received via the cold fluid line 406 to provide coolant at a particular desired temperature. Such coolant is then provided via a mixture fluid line 430 to a diagnostic module 432, which then provides coolant to the battery module 150 via fluid line 434.

In some example embodiments, coolant is then discharged from the battery module 150 and is returned to the diagnostic module 432 via return line 436. The diagnostic module 432 then provides return fluid to the TCU 408 via fluid line 438, and the TCU 408 in turn provides fluid back to the coolant supply system 402 via reservoir return line 440. As described in more detail below, the diagnostic module 432 may include several sensors that indicate via signal line 441 a state of the coolant to enable the TCU 408 to determine whether the system is operating as expected.

Similarly, in some example embodiments, the TCU 410 is configured to control mixture of hot coolant received via the hot fluid line 404 and cold coolant received via the cold fluid line 406 to provide coolant at a particular desired temperature. Such coolant is then provided via a mixture fluid line 442 to a diagnostic module 444, which then provides coolant to the battery module 152 via fluid line 446.

In some example embodiments, coolant is then discharged from the battery module 152 and is returned to the diagnostic module 444 via return line 448. The diagnostic module 444 then provides return fluid to the TCU 408 via fluid line 450, and the TCU 408 in turn provides fluid back to the coolant supply system 402 via reservoir fluid line 452. The diagnostic module 444 may include several sensors that indicate via signal line 453 a state of the coolant to enable the TCU 410 to determine whether the system is operating as expected.

Similarly, in some example embodiments, the TCU 412 is configured to control mixture of hot coolant received via the hot fluid line 404 and cold coolant received via the cold fluid line 406 to provide coolant at a particular desired temperature. Such coolant is then provided via a mixture fluid line 454 to a diagnostic module 456, which then provides coolant to the battery module 156 via fluid line 458.

Coolant is then discharged from the battery module 156 and is returned to the diagnostic module 456 via return line 460. The diagnostic module 456 then provides return fluid to the TCU 412 via fluid line 462, and the TCU 408 in turn provides fluid back to the coolant supply system 402 via reservoir fluid line 464. The diagnostic module 456 may include several sensors that indicate via signal line 466 a state of the coolant to enable the TCU 412 to determine whether the system is operating as expected.

Components of the thermal control system 400 may be configured to work in an interconnected fashion with each other and/or with other components coupled to respective systems. One or more of the described operations or components of the thermal control system 400 may be divided up into additional operational or physical components, or combined into fewer operational or physical components. In some further examples, additional operational and/or physical components may be added to the thermal control system 400. Still further, any of the components or modules of the thermal control system 400 may include or be provided in the form of a processor (e.g., a microprocessor, a digital signal processor, etc.) configured to execute program code including one or more instructions for implementing logical operations described herein.

The thermal control system 400 may further include any type of computer readable medium (non-transitory medium) or memory, for example, such as a storage device including a disk or hard drive, to store the program code that when executed by one or more processors cause the thermal control system 400 to perform the operations described above. In an example, the thermal control system 400 may be included within other systems.

Further, modules that are depicted as separate from each other can be integrated together. For example, the diagnostic module 432 may be comprised in the TCU 408. In another example, at least some of the operations, of the TCU 408 can be implemented in the coolant supply system 402.

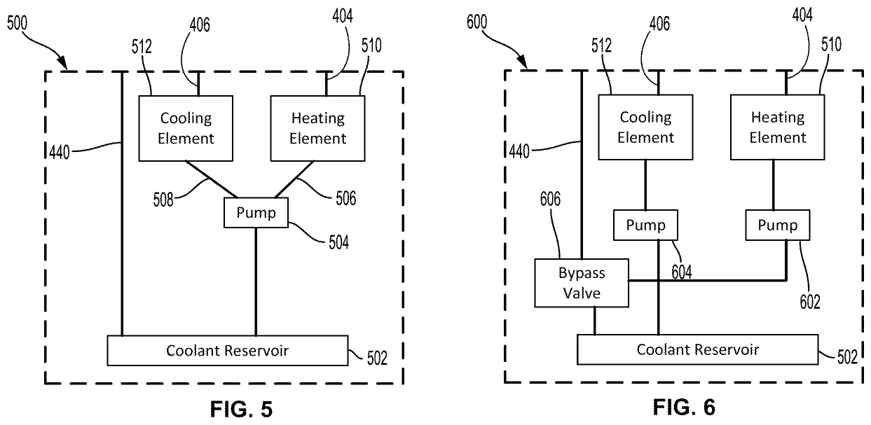

The coolant supply system 402 can have different configurations. FIG. 5 is a block diagram showing a coolant supply system 500, according to example embodiments of the present invention. The coolant supply system 500 may represent the coolant supply system 402, for example.

The coolant supply system 500 may have a coolant tank or coolant reservoir 502 configured to store coolant (e.g., ethylene glycol) at a low pressure. The coolant supply system 500 may also include a pump 504. In an example embodiment, the pump 504 is an electrically-actuated pump, e.g., driven by an electric motor that receives commands from the thermal management control module 420. The pump 504 may be configured to draw fluid from the coolant reservoir 502 and provide fluid flow via a first fluid line 506 and a second fluid line 508.

The coolant supply system 500 may include a heating element 510 and a cooling element 512. The heating element 510 may be configured to heat the coolant received from the pump 504 via the first fluid line 506 to a particular temperature.

The heating element 510 may be any device that generates and/or radiates heat. The heating element 510 may be configured, for example, to convert electrical energy into heat through the process of Joule heating. Electric current through the heating element 510 encounters resistance, resulting in heating of the heating element 510. In another example, the heating element 510 may be a source of heat generated somewhere else in the vehicle 100 (e.g., from electric motors or controllers). In another example, the heating element 510 may be a thermoelectric heat pump. The heating element 510 may be disposed adjacent or about the hot fluid line 404 to heat coolant flowing therein.

The cooling element 512 may be configured to reduce temperature of the coolant received from the pump 504 via the second fluid line 508 to cool the coolant to a particular temperature. The cooling element 512 may be any device that absorbs heat. In an example, the cooling element 512 may involve vapor-compression refrigeration, in which the refrigerant undergoes phase changes similar to an air-conditioning system. In another example, the cooling element 512 may involve thermoelectric cooling that uses the Peltier effect to create a heat flux at the junction of two different types of materials. Such cooling element may include a solid-state active heat pump, which transfers heat from one side of the device to the other, with consumption of electrical energy, depending on the direction of electric current, for example. The cooling element 512 can be disposed adjacent or about the cold fluid line 406 to reduce the temperature of coolant flowing therein.

In an example embodiment, rather than using separate heating and cooling element, a heat pump can be used to either heat or cool the coolant as desired to provide coolant at a particular desired temperature through a single fluid line to the TCUs.

FIG. 6 is a block diagram showing another coolant supply system 600, according to example embodiments of the present invention. The coolant supply system 600 may represent the coolant supply system 402, for example. Components that are common between the coolant supply system 500 and the coolant supply system 600 are designated with the same reference numbers.

The coolant supply system 600 differs from the coolant supply system 500 in that, rather than having a single pump, the coolant supply system 600 has two separate pumps. Particularly, the coolant supply system 600 has a first pump 602 configured to draw coolant from the coolant reservoir 502 and provide coolant to the heating element 510 and a second pump 604 configured to draw coolant from the coolant reservoir 502 and provide coolant to the cooling element 512.

Further, the coolant supply system 600 may have a bypass valve 606 disposed in the reservoir return line 440. Under some operating conditions, coolant returning from a battery module may have a high temperature. For example, if such battery module is operating at a temperature that is higher than a target temperature, the respective TCU may provide cold coolant to absorb heat from the battery module and reduce its temperature. As the coolant absorbs heat, its temperature increases. Thus, coolant returning to the coolant reservoir 502 via the reservoir return line 440 may be hot.

Another battery module may require hot fluid. For instance, such battery module may require hot coolant for preconditioning the battery module for high power or fast charging. In this case, the thermal management control module 420 or any valve controller may actuate the bypass valve 606 to direct at least a portion of hot coolant from the reservoir return line 440 to the first pump 602 providing coolant to the heating element 510. With this configuration, as the coolant from the reservoir return line 440 is hot, the heating element 510 adds a smaller amount of heat to the coolant compared to a configuration where no hot coolant is provided from the reservoir return line 440 via the bypass valve 606. As such, the heating element 510 runs more efficiently.

The hot and cold coolant generated by the coolant supply system 402 (e.g., the coolant supply system 500, 600) may be provided to respective TCUs of the thermal control system 400 via hot fluid line 404 and the cold fluid line 406. The TCUs may then use the hot and cold coolant to control temperature level of the respective battery modules.

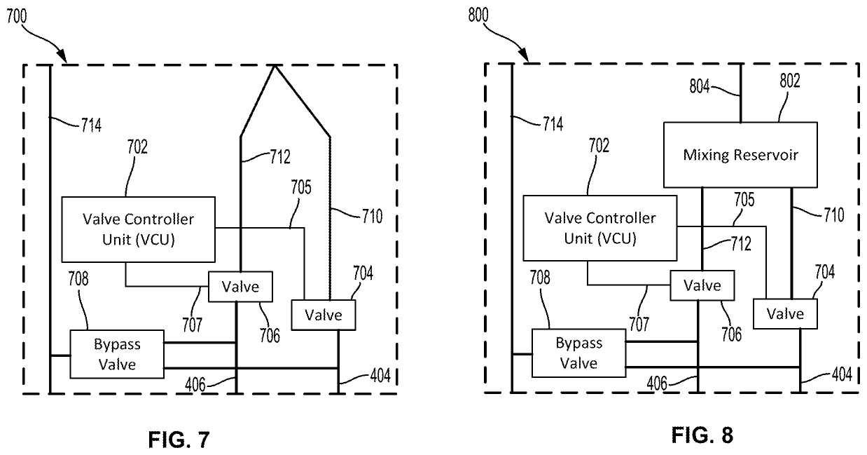

FIG. 7 is a block diagram showing a TCU 700, according to example embodiments of the present invention. The TCU 700 may represent any of the TCUs 408, 410, 412, for example.

In an example embodiment, the TCU 700 may include a valve control unit 702, a hot coolant control valve 704, a cold coolant control valve 706, and a bypass valve 708. The hot coolant control valve 704 is configured to control flow of hot coolant received via the hot fluid line 404. Similarly, in an example embodiment, the cold coolant control valve 706 is configured to control flow of cold coolant received via the cold fluid line 406.

For example, if the hot coolant control valve 704 is open, hot coolant is allowed to flow to hot coolant line 710, and if the cold coolant control valve 706 is open, cold coolant is allowed to flow to cold coolant line 712. The hot coolant line 710 and the cold coolant line 712 then merge into a mixture fluid line (e.g., the mixture fluid line 430, 442, 454) that is provided to the respective battery module.

The valve control unit 702 may operate as a valve controller having electronic drivers or circuitry configured to actuate the hot coolant control valve 704 via command signal line 705 and actuate the cold coolant control valve 706 via command signal line 707 to generate fluid having a particular temperature at the mixture fluid line. Particularly, the valve control unit 702 may be configured to receive a target temperature from the thermal management control module 420, and receive an actual temperature of the battery module (e.g., via the sensor signal line 414, 416, 418). The valve control unit 702 may compare the target temperature and the actual temperature, and may responsively control actuation of the hot coolant control valve 704 and the cold coolant control valve 706 to provide coolant to the battery module to achieve the target temperature (i.e., reduce any discrepancy or difference between the target temperature and the actual temperature).

In one example, the hot coolant control valve 704 and the cold coolant control valve 706 are configured as on/off valves. In other words, each of the hot coolant control valve 704 and the cold coolant control valve 706 can operate in either a fully open state to allow fluid flow therethrough or a fully closed state to block fluid flow.

In another example, the hot coolant control valve 704 and the cold coolant control valve 706 can be proportional valves. In this example, the extent of opening of a respective valve, which determines the fluid flow rate through the valve, is proportional to a magnitude of the electric command (e.g., voltage or current magnitude) provided by the valve control unit 702 to the valve. This configuration may allow the valve control unit 702 to control precisely the temperature of coolant provided to the battery module.

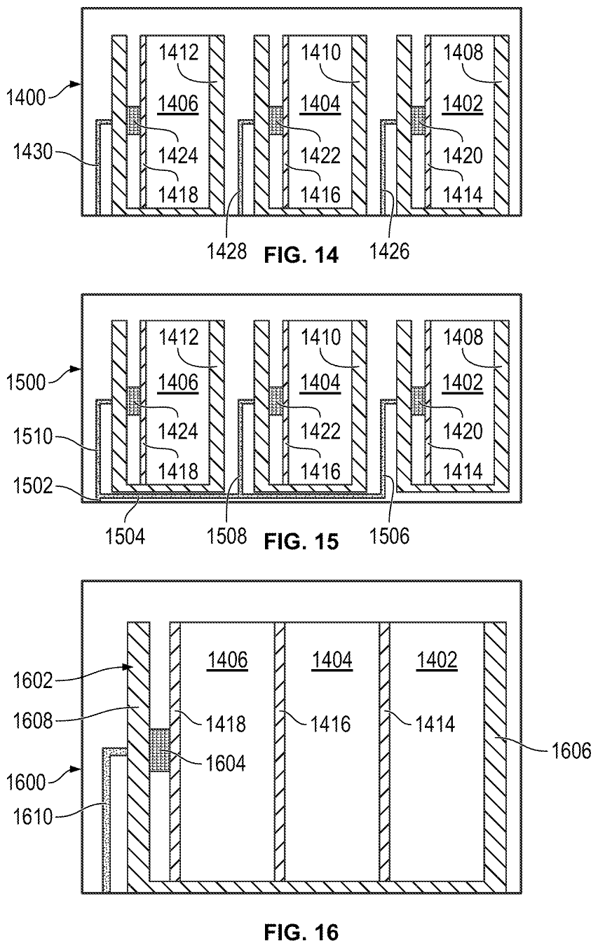

The coolant discharged from the TCU 700 (e.g., the mixed hot and cold coolant) may be provided to the battery module to achieve the target temperature in the battery module. For example, the battery module may have plates (see e.g., pressure distribution plates 1414, 1416, 1418 in FIGS. 14-16 described below) interfacing with battery cells within the battery module, and the plates may have fluid conduits or channels formed therein. Coolant flowing through the channels can either (i) absorb heat from the battery module if the temperature of the coolant is less than a respective temperature of the battery module, or (ii) transfer thermal energy to the battery module to increase its temperature if the temperature of the coolant is greater than the respective temperature of the battery module.

In some example embodiments, coolant discharged from the battery module flows through a respective diagnostic module as described above with respect to FIG. 4, then provided to the TCU 700 via return line 714. The bypass valve 708 may be configured to relieve fluid in the hot fluid line 404 and/or the cold fluid line 406 to the return line 714 if coolant pressure level in the hot fluid line 404 and/or the cold fluid line 406 exceeds a threshold pressure value. For example, if the hot coolant control valve 704 is closed, pressure level can increase in the hot fluid line 404 as coolant is blocked by the hot coolant control valve 704. In this case, the bypass valve 708 opens to relieve coolant to the return line 714, which is fluidly coupled to the coolant reservoir 502 of the coolant supply system 402.

Similarly, in some example embodiments, if the cold coolant control valve 706 is closed, pressure level can increase in the cold fluid line 406 as coolant is blocked by the cold coolant control valve 706. In this case, the bypass valve 708 opens to relieve fluid to the return line 714, which is fluidly coupled to the coolant reservoir 502 of the coolant supply system 402.

FIG. 8 is a block diagram showing another TCU 800, according to example embodiments of the present invention. The TCU 800 may represent any of TCUs 408, 410, 412, for example. Components that are common between the TCU 700 and the TCU 800 are designated with the same reference numbers.

The TCU 800 differs from the TCU 700 in that, rather than directly merging the hot coolant line 710 with the cold coolant line 712 into a single fluid line, the TCU 800 includes a mixing reservoir 802 that receives coolant from the hot coolant line 710 and the cold coolant line 712. Coolants from the hot coolant line 710 and the cold coolant line 712 may be allowed to mix in the mixing reservoir 802, which allows the coolant to have a uniform temperature between the coolant temperature of the hot coolant line 710 and the coolant temperature of the cold coolant line 712. Coolant may then be provided via a mixture fluid line 804, which may represent any of the mixture fluid lines 430, 442, 454, to the respective diagnostic module.

Components of the TCUs 700, 800 are not meant to be limiting. More or fewer components could be used, and various configurations of the components described above could be used. For example, check valves could be used to prevent back flow of coolant in the coolant lines. Different types of valves could be used, such as cartridge valves, sectional valves, spool valves, poppet valves, etc. could be used. Further, manifolds that integrate several components could also be used.

As described above, in some example embodiments, coolant discharged from the TCUs flows through a diagnostic module (e.g., any of the diagnostic modules 432, 444, 456) before being provided to the respective battery module. The diagnostic module may have sensors that detect characteristics of the coolant to provide diagnostic feedback to the TCUs, which can then determine whether the thermal control system 400 is operating as expected or whether a malfunction has occurred. Further, the sensors could facilitate implementing closed loop feedback control on the temperature of coolant provided to the battery module to achieve the target temperature.

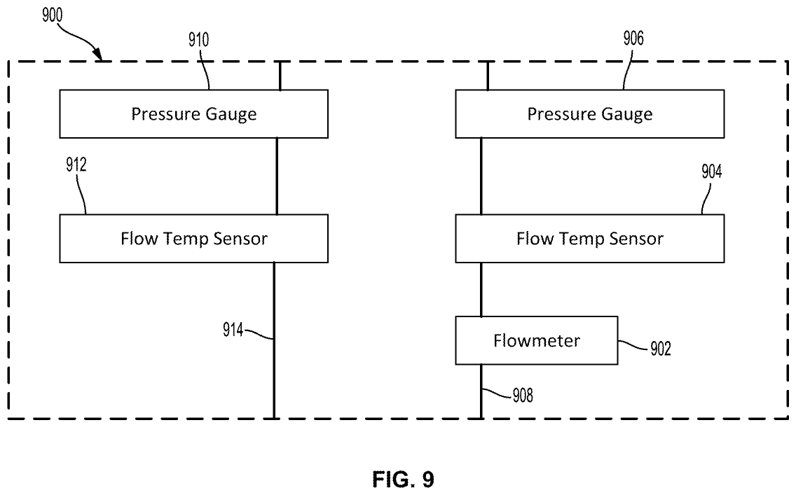

FIG. 9 is a block diagram of a diagnostic module 900, according to example embodiments of the present invention. The diagnostic module 900 may include a flow meter 902, a temperature sensor 904 and a pressure gauge 906 (i.e., a pressure sensor) mounted to a mixture fluid line 908 that fluidly couples a TCU to the diagnostic module 900. The mixture fluid line 908 represents any of the mixture fluid lines 430, 442, 454, 804 described above, for example.

The TCU can implement closed loop feedback control using temperature sensor information from the temperature sensor 904 to control precisely the temperature of the coolant provided to the battery module to achieve the target temperature for the battery module. The flow meter 902 may provide sensor information indicative of coolant flow rate through the mixture fluid line 908. The TCU may use such flow rate sensor information to control actuation of the hot coolant control valve 704 and the cold coolant control valve 706 to adjust coolant flow rate as desired, for example.

Further, the TCU may use sensor information from the diagnostic module 900 for fault detection. For example, if the valve control unit 702 has not commanded either the hot coolant control valve 704 or the cold coolant control valve 706 to open, yet the flow meter 902 or the pressure gauge 906 indicates that there is coolant flowing through the mixture fluid line 908, then the TCU can determine that at least one of the hot coolant control valve 704 or the cold coolant control valve 706 is stuck open.

The diagnostic module 900 may also include a pressure gauge 910 and a temperature sensor 912 mounted to return line 914 providing coolant discharged from the battery module back to the TCU. The pressure gauge 910 and the temperature sensor 912 may provide sensor information to the TCU indicating a state of the coolant discharged from the battery module. The TCU may responsively adjust commands to the valves, for example, of the TCU to adjust the state of the coolant or may use the sensor information to determine whether a malfunction has occurred.

The diagnostic module 900 depicted in FIG. 9 is an example for illustration. Other sensors could be used. For example, the diagnostic module 900 can include sensors configured to measure various properties and characteristics of the coolant to determine a state of health of the coolant (e.g., level of contaminants in the coolant) and whether the coolant need to be changed. Such sensors may be fluid contact sensors where a sensing element of the sensor is subjected to coolant flowing through the diagnostic module 900, while other sensors may be non-fluid contact sensors (measure fluid properties without contacting the coolant) such as optical sensors Advantageously, the thermal control system 400 may allow controlling temperature of each individual battery module independently. The temperature of each battery module may thus be controlled dynamically based on local conditions of the battery module regardless of condition of the other battery modules.

In addition to thermal control of the battery modules, it may be desirable to apply pressure to battery cells of the battery modules to enhance their capacity, reduce internal Ohmic resistance, and increase their lifespan. In conventional battery systems, battery cells may be disposed between two plates that are bolted together to exert pressure onto the battery cells. Battery cells may expand during charging and discharging, and such expansion may cause a battery cell disposed between the two plates to be subjected to uncontrolled dynamic pressure instead of a desired static pressure.

It may thus be desirable to configure a pressure control system to allow applying an accurate constant pressure on the battery cells of a battery module. As described above with respect to FIGS. 2-3, a fluid-based pressure control system can be used to apply pressure, and control pressure level applied, to battery cells of the battery modules. Such a pressure control system may be configured to apply a desired pressure while maintaining the overall cell stack thickness. Further, the pressure control system may be configured to apply and a maintain specific pressure or compressed thickness to the battery cells within one module that is different from pressure and compressed thickness applied to the battery cells of another battery module.

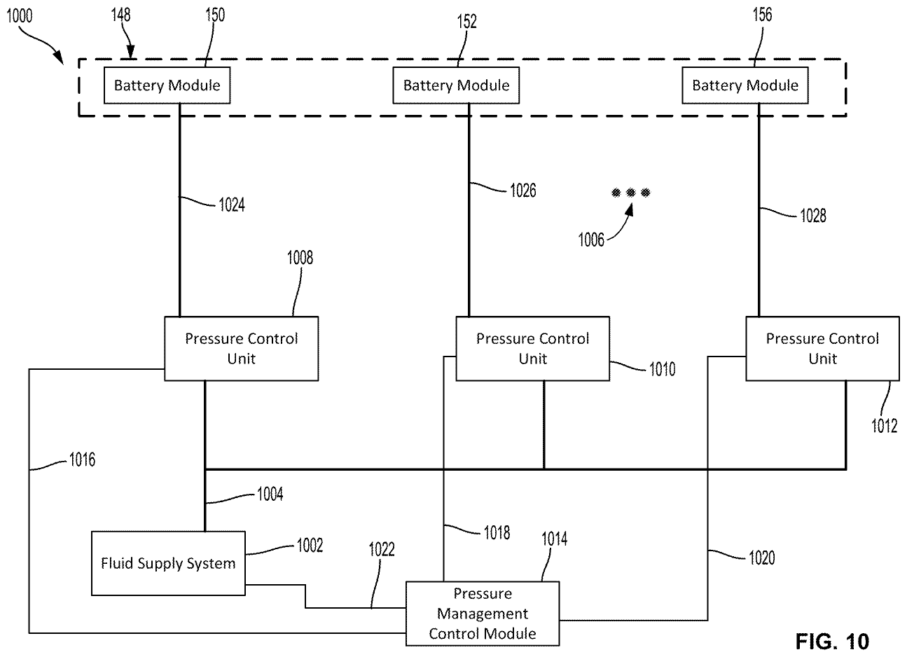

FIG. 10 is a block diagram for a pressure control system 1000, according to example embodiments of the present invention. The pressure control system 1000 may represent any of the pressure control systems 172, 203, 306, for example.

The pressure control system 1000 may include a fluid supply system 1002. The fluid supply system 1002 represents the fluid supply system 204 or the fluid supply system 302, for example. The fluid supply system 1002 may be configured to provide fluid through fluid line 1004 to respective Pressure Control Units (PCUs) that control pressure applied to cells of the respective battery modules.

For example, the pressure control system 1000 may include PCU 1008 configured to control pressure applied to cells of the battery module 150, PCU 1010 configured to control pressure applied to cells of the battery module 152, and PCU 1012 configured to control pressure applied to cells of the battery module 156. Only three battery modules are shown, but it should be understood that any number of battery modules can be disposed in the battery 148 as represented by ellipses 1006, and each battery module has a respective PCU that independently controls pressure applied to cells of the battery module.

The pressure control system 1000 may include a pressure management control module 1014. The pressure management control module 1014 can include one or more processors along with memory and programmable input/output peripherals. A processor can include a general purpose processor (e.g., a single core microprocessor or a multicore microprocessor), or a special purpose processor (e.g., a digital signal processor, a graphics processor, or an application specific integrated circuit (ASIC) processor). A processor can be configured to execute computer-readable program instructions (CRPI) to perform the operations described throughout herein. A processor can be configured to execute hard-coded functionality in addition to or as an alternative to software-coded functionality (e.g., via CRPI).

The pressure management control module 1014 is configured to set a respective desired or target pressure for each of the battery modules and provide such target pressure to the respective PCU. For example, the pressure management control module 1014 provides a target pressure via a signal line 1016 for the battery module 150 to the PCU 1008, provides a target pressure via a signal line 1018 for the battery module 152 to the PCU 1010, and provides a target pressure via a signal line 1020 for the battery module 156 to the PCU 1012.

The pressure management control module 1014 may also provide a command signal via a signal line 1022 to the fluid supply system 1002. The command signal may indicate to the fluid supply system 1002 whether to provide fluid to the PCUs 1008-1012, and may also indicate the fluid flow rate to be supplied to the PCUs 1008-1012.

Each PCU of the PCUs 1008-1012 may control the pressure applied by fluid provided to the respective battery module based on the target pressure set by the pressure management control module 1014. Particularly, in some example embodiments, the PCU 1008 provides fluid to the battery module 150 via fluid line 1024, the PCU 1010 provides fluid to the battery module 152 via fluid line 1026, and the PCU 1012 provides fluid to the battery module 156 via fluid line 1028. Pressure may be applied to the battery cells in the respective battery module through a pressure mechanism disposed within the battery module as described below with respect to FIGS. 14-16.

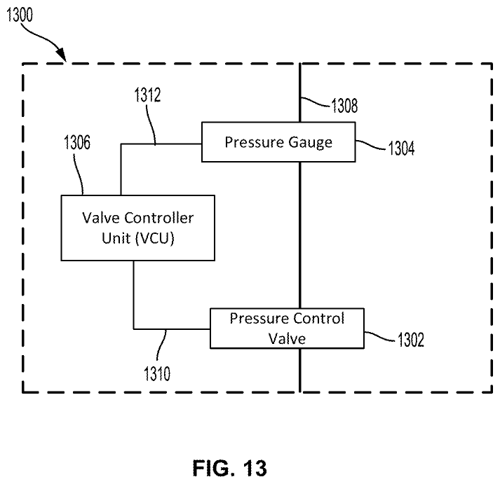

In an example embodiment, as described below with respect to FIG. 13, a pressure gauge within the PCU may provide sensor information indicating the actual pressure of fluid. The PCU can then compare the actual pressure to the target pressure, and adjust the pressure level of the fluid to achieve the target pressure.

Components of the pressure control system 1000 may be configured to work in an interconnected fashion with each other and/or with other components coupled to respective systems. One or more of the described operations or components of the pressure control system 1000 may be divided up into additional operational or physical components, or combined into fewer operational or physical components. In some further examples, additional operational and/or physical components may be added to the pressure control system 1000. Still further, any of the components or modules of the pressure control system 1000 may include or be provided in the form of a processor (e.g., a microprocessor, a digital signal processor, etc.) configured to execute program code including one or more instructions for implementing logical operations described herein.

The pressure control system 1000 may further include any type of computer readable medium (non-transitory medium) or memory, for example, such as a storage device including a disk or hard drive, to store the program code that when executed by one or more processors cause the pressure control system 1000 to perform the operations described above. In an example, the pressure control system 1000 may be included within other systems. Further, modules that are depicted as separate from each other can be integrated together. For example, the PCUs 1008-1012 may be integrated into the pressure management control module 1014.

The fluid supply system 1002 can have different configurations. For example, a different configuration may be used based on the type of fluid used to apply pressure. For instance, in one example embodiment, a liquid could be used, and in another example embodiment, gas (e.g., air) could be used.

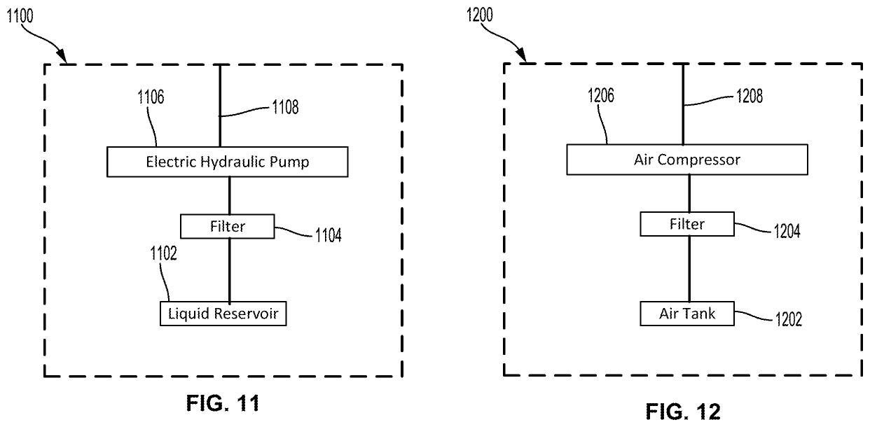

FIG. 11 is a block diagram showing a fluid supply system 1100, according to example embodiments of the present invention. The fluid supply system 1100 may represent the fluid supply system 1002, for example.

The fluid supply system 1100 may have a liquid reservoir 1102 configured to store liquid (e.g., hydraulic fluid) at a low pressure. The fluid supply system 1100 may also include a filter 1104. The fluid supply system 1100 may further include and a pump 1106. The filter 1104 may prevent contaminants from flowing to the pump 1106 and damaging it. The filter 1104 may also prevent any debris from going into the liquid reservoir 1102 when it is being filled with liquid.

In an example embodiment, the pump 1106 may be an electrically-actuated pump, e.g., driven by an electric motor that receives commands from the pressure management control module 1014. The pump 1106 may be configured to draw fluid from the liquid reservoir 1102, through the filter 1104, and provide fluid flow via a fluid line 1108 to the PCUs 1008-1012. In one example embodiment, as described above with respect to FIG. 3, the liquid can be the coolant used for the thermal control system 400. In this example embodiment, the pumps of the thermal control system 400 (e.g., the pump 504) may be used to provide fluid to the PCUs.

FIG. 12 is a block diagram showing another fluid supply system 1200, according to example embodiments of the present invention. The fluid supply system 1200 may represent the fluid supply system 1002, for example.

The fluid supply system 1200 differs from the fluid supply system 1100 in that, rather than using liquid, the fluid supply system 1200 uses compressed air as the fluid provided to the PCUs to apply pressure to the battery cells. Particularly, in some example embodiments, the fluid supply system 1200 may have an air tank 1202, a filter 1204, and an air compressor 1206.

The filter 1204 may protect the air tank 1202 and the air compressor 1206 from contaminants or debris. The air compressor 1206 may be configured to draw air from the air tank 1202 through the filter 1204, compress the air, and provide pressurized air via fluid line 1208 to the PCUs 1008-1012. Particularly, the air compressor 1206 may include a mechanical device (e.g., a piston) that increases the pressure of a gas by reducing its volume.

The fluid supply systems 1100, 1200 may include more components. For example, the fluid supply systems 1100, 1200 may further include relief valves that protect the pump 1106 or the air compressor 1206 against over-pressurization. In another example, the fluid supply systems 1100, 1200 may further include check valves that prevent back flow in the fluid lines.

If the fluid supply system 1002 is liquid based (e.g., the fluid supply system 1100), then the PCUs may include hydraulic or liquid flow and pressure control valve. On the other hand, if the fluid supply system 1002 uses gas (e.g., the fluid supply system 1200), then the PCUs may include pneumatic components. Whether the PCUs receive liquid or compressed gas, the PCUs are configured to regulate pressure level of the fluid to apply a target pressure to cells of the respective battery modules.

FIG. 13 is a block diagram of a PCU 1300, according to example embodiments of the present invention. The PCU 1300 may represent any of the PCUs 1008, 1010, 1012, for example.

In an example embodiment, the PCU 1300 may include a pressure control valve 1302, a pressure gauge 1304, and a valve control unit 1306. The pressure control valve 1302 may be configured to achieve and maintain a set or commanded pressure in fluid line 1308. Several types of pressure control valves could be used including relief, reducing, sequence, counterbalance, and unloading valves.

For instance, the pressure control valve 1302 may be include a pressure-reducing valve configured to be set for a desired downstream pressure. In another example, the pressure control valve 1302 may be include a pressure relief valve used to control or limit the pressure in the fluid line 1308. In another example, the pressure control valve 1302 may combine or integrate a pressure relief function with a pressure reducing function, and can be referred to as a pressure relieving-reducing valve. In another example, the pressure control valve 1302 can include a valve assembly or manifold integrating several valves configured to operate together to maintain a set pressure level downstream of the pressure control valve 1302.

In an example embodiment, the valve control unit 1306 operates as a valve controller having electronic drivers or circuitry configured to actuate the pressure control valve 1302 via command signal line 1310 to generate fluid having a particular pressure level in the fluid line 1308. Particularly, in some example embodiments, the valve control unit 1306 is configured to receive a target pressure from the pressure management control module 1014, and receive an actual pressure level from the pressure gauge 1304 via sensor signal line 1312. The valve control unit 1306 then responsively controls actuation of the pressure control valve 1302 to provide fluid to the battery module and achieve the target pressure (i.e., reduce any discrepancy between the target pressure and the actual pressure). In this example embodiment, the pressure control valve 1302 may be electrically-actuated such that a command signal provided via the command signal line 1310 from the valve control unit 1306 sets a pressure level at the outlet of the pressure control valve 1302 and the fluid line 1308.

In one example, the pressure control valve 1302 is configured as an on/off valve. In other words, the pressure control valve 1302 can operate in either a fully open state to allow fluid flow therethrough and increase pressure level downstream, or a fully closed state to block fluid flow and reduce pressure level downstream.

In another example, the pressure control valve 1302 is configured as a proportional valve. In this example, the extent of opening of the pressure control valve 1302, and thus the pressure level downstream, is proportional to a magnitude of an electric command (e.g., voltage or current magnitude) provided by the valve control unit 1306 via the command signal line 1310 to the pressure control valve 1302. This configuration may allow the valve control unit 1306 to control precisely the pressure level of fluid provided to the battery module.

The configuration of the PCUs 1300 is not meant to be limiting. More or fewer components could be used, and various configurations of the components described above could be used. For example, check valves could be used to prevent back flow of fluid in the fluid lines. Different types of valves could be used, such as cartridge valves, sectional valves, spool valves, poppet valves, etc. could be used. Further, manifolds that integrate several components could also be used. Further, the PCU 1300 may include several pressure control valve to provide fluid at different pressure levels for respective battery cells of a battery module.

The fluid discharged from the PCU 1300 is provided to the respective battery module to achieve the target pressure to be applied to cells of the battery module. For example, the battery module may include pressure distribution plates that are used to apply pressure to the battery cells.

FIG. 14 illustrates a pressure mechanism configuration for applying pressure to individual battery cells, according to example embodiments of the present invention. Particularly, FIG. 14 depicts a cross-sectional side view of a battery module 1400 that can represents any of the battery modules of the battery 148, for example.

The battery module 1400 may have a plurality of battery cells such as battery cell 1402, battery cell 1404, and battery cell 1406. Three battery cells are depicted as an example for illustration only. More or fewer battery cells could be used. The number of battery cells placed in a battery module is based on the desired voltage and capacity of the battery module.

The battery module 1400 may further include respective cell holders that holds or retains the battery cells within the battery module 1400. For example, cell holder 1408 retains or holds the battery cell 1402 within the battery module 1400. The cell holder 1408 is depicted as having a yoke shape (e.g., a U-shaped cell holder) as an example and the battery cell 1402 is disposed between the two sides of the yoke. However, the cell holder can have other shapes as well (I-beam, a C-channel, etc.). Similarly, in some example embodiments, a cell holder 1410 retains the battery cell 1404, and a cell holder 1412 retains the battery cell 1406.

The battery module 1400 may also include pressure distribution plates configured to apply pressure to the battery cells 1402-1406. For example, the battery module 1400 may have pressure distribution plate 1414 interfacing with or contacting one side of the battery cell 1402. The opposite side of the battery cell 1402 interfaces with or contacts an interior surface of the cell holder 1408 as depicted in FIG. 14. With this configuration, the battery cell 1402 is interposed between one side of the cell holder 1408 and the pressure distribution plate 1414. Similarly, the battery cell 1404 is interposed between one side of the cell holder 1410 and a pressure distribution plate 1416, and the battery cell 1406 is interposed between one side of the cell holder 1412 and a pressure distribution plate 1418.

In an example embodiment, the pressure distribution plates 1414-1418 could be thermally conductive, but electrically insulating. Particularly, the pressure distribution plates 1414-1418 may have channels embedded therein to allow coolant of the thermal control system 400 to flow therethrough to cool or heat the pressure distribution plates 1414-1418. The pressure distribution plates 1414-1418, being thermally conductive, transfer heat to or absorb heat from the respective battery cells to adjust the temperature of the respective battery cells.

At the same time, the pressure distribution plates 1414-1418 may electrically insulate the battery cells 1402-1406. For example, the pressure distribution plates 1414-1418 may be made of a material that is not electrically conductive or may be plated by or coupled to an electrically-insulating material (e.g., a polymer or a thermal pad).

The battery module 1400 may further include respective pistons configured to apply pressure to the battery cells via the respective pressure distribution plates. For example, the battery module 1400 has a piston 1420 that interfaces with the pressure distribution plate 1414. In the example embodiment shown in FIG. 14, the piston 1420 is interposed between the pressure distribution plate 1414 and the cell holder 1408 (i.e., the side of the cell holder 1408 that is opposite the side interfacing with the battery cell 1402). Similarly, in some example embodiments, a piston 1422 is interposed between the cell holder 1410 and the pressure distribution plate 1416, and a piston 1424 is interposed between the cell holder 1412 and the pressure distribution plate 1418.

The battery module 1400 may also include fluid lines providing fluid from the respective PCU (e.g., one of the PCUs 1008-1012) to the pistons 1420-1424, respectively. Particularly, in some example embodiments, a fluid line 1426 provides fluid through the cell holder 1408 to the piston 1420, a fluid line 1428 provides fluid through the cell holder 1410 to the piston 1422, and a fluid line 1430 provides fluid through the cell holder 1412 to the piston 1424. Thus, once pressurized fluid is provided from the respective PCU through the fluid lines 1426-1430, the fluid applies pressure on the pistons 1420-1424, and such pressure is transmitted to the pressure distribution plates 1414-1418, which in turn spreads the pressure out evenly to the respective battery cells.

For example, if a target pressure level to be applied to the battery cell 1402 is P₁ and the surface area of the pressure distribution plate 1414 is A₁, then the desired force F to be applied to the battery cell 1402 can be determined as F=P₁·A₁. If the surface area of the piston 1420 on which fluid from the fluid line 1426 acts is A₂, then a target fluid pressure of fluid from the fluid line 1426 that achieves the desired force F can be determined as P₂=F/A₂. As such, the PCU determines a target fluid pressure for fluid provided through the fluid line 1426 to be P₂, and provide fluid having fluid pressure P₂, such that the target pressure P₁ is applied to the battery cell 1402.

In this manner, the battery cell 1402 is clamped or squeezed by a desired pressure Pi that can be set by the pressure management control module 1014 and controlled by the respective PCU. A target pressure can be applied to the battery cells 1404-1406 in a similar manner.

In the example embodiment of FIG. 14, the fluid lines 1426-1430 are independent from each other such that fluid at different pressure levels can be supplied through the fluid lines 1426-1430. This configuration may allow applying a different pressure level to each battery cell independently from the other battery cells. For example, the PCU of the battery module 1400 may have three pressure control valves (similar to the pressure control valve 1302), each valve controlling pressure level of fluid supplied to a respective fluid line of the fluid lines 1426-1430. In another example, the PCU may have one pressure control valve, and the fluid lines 1426-1430 may each have an additional valve (e.g., a respective pressure reducing valve) that adjusts individual pressure level of fluid supplied to the respective piston. Thus, the pressure level applied to each battery cell may be controlled independently. However, in other example embodiments, the pressure level of fluid supplied to all the cells of a battery module may be the same.

FIG. 15 illustrates a pressure mechanism configuration for applying the same pressure to battery cells of a battery module 1500, according to example embodiments of the present invention. Particularly, FIG. 15 depicts a cross-sectional side view of the battery module 1500 that can represents any of the battery modules of the battery 148, for example. Components that are common between the battery module 1400 and the battery module 1500 are designated with the same reference numbers.

The configuration of the battery module 1500 differs from the configuration of the battery module 1400 in that, rather than having three independent fluid lines providing fluid to the respective pistons, the battery module 1500 has an inlet fluid line 1502 that receives fluid from the respective PCU and a common fluid line 1504 that provides fluid to all the pistons 1420-1424 via branch 1506, branch 1508, and branch 1510, respectively. Thus, in this example embodiment, the battery module 1500 may have only one fluid inlet connection to supply fluid to the battery cells 1402-1406, and the pressure applied to all the battery cells 1402-1406 is the same.

FIG. 16 illustrates another pressure mechanism configuration for applying pressure to battery cells of a battery module 1600, according to example embodiments of the present invention. Particularly, FIG. 16 depicts a cross-sectional side view of the battery module 1600 that can represents any of the battery modules of the battery 148, for example. Components that are common between the battery modules 1400, 1500 and the battery module 1600 are designated with the same reference numbers.

Rather than having a cell holder and piston for each battery cell, the battery module 1600 may have a cells holder 1602 for all the battery cells 1402-1406, and a piston 1604 for applying pressure to all the battery cells 1402-1406. In particular, in some example embodiments, the battery cell 1402 is interposed between a first side 1606 of the cells holder 1602 and the pressure distribution plate 1414, whereas the battery cell 1404 is interposed between the pressure distribution plate 1414 and the pressure distribution plate 1416, and the battery cell 1406 is interposed between the pressure distribution plate 1416 and the pressure distribution plate 1418. The piston 1604 is interposed between the pressure distribution plate 1418 and a second side 1608 of the cells holder 1602, opposite the first side 1606.

The battery module 1600 may have a fluid line 1610 that receives fluid from the respective PCU. The fluid flows through the second side 1608 of the cells holder 1602 and applies pressure on the piston 1604, which in turn applies pressure on the pressure distribution plate 1418. As a result, the battery cell 1406 is squeezed against the pressure distribution plate 1416, the battery cell 1404 is squeezed against the pressure distribution plate 1414, and the battery cell is 1402 is squeezed against the first side 1606 of the cells holder 1602. In this manner, a uniform pressure may be applied to all the battery cells 1402-1406.

In an example embodiment, the battery module 1600 may have only the pressure distribution plate 1418, without the pressure distribution plates 1414, 1416. As such, the battery module 1600 may include at least one pressure distribution plate interfacing with the piston 1604 to apply pressure to the battery cells 1402-1406.

The pressure mechanisms described in FIGS. 14-16 are not meant to be limiting examples. Other mechanisms could be used. For example, the battery modules can include other types of actuators (e.g., hydraulic or pneumatic cylinder actuators) configured to receive fluid and apply pressure on the battery cells. In another example embodiment, the battery module may include an inflatable plug or bladder that inflates when it receives fluid therein, and applies pressure against surfaces of the battery cells when inflated.

Regardless of pressure mechanism used, particular desired pressures are applied to the battery cells to maintain their thickness, mitigate bulging, increase life and capacity of the battery cells, and reduce their internal Ohmic resistance, thereby enhancing the performance of the battery 148.

In an example embodiment, the thermal control system 400 and the pressure control system 1000 may further operate as a fire suppression system in the case of a fire that occurs because of a strong exothermic reaction, e.g., in a thermal runaway event. A thermal runaway may indicate a condition in which an electrochemical battery cell overheats, and is damaged through internal heat generation. This may be caused by overcharge or high current discharge and other abusive conditions.

In an example embodiment, the pistons (e.g., any of the pistons described above with respect to FIGS. 14-16) may have respective valves coupled thereto. If the temperature sensor within a battery module indicates that the temperature increased beyond a threshold temperature associated with a thermal runaway event or fire, the pressure control system 1000 may actuate the valves coupled to the pistons to allow fluid to exit from the pistons and suppress any fire in the battery modules, while the other battery modules remain unaffected. In another example embodiment, additionally or alternatively, a film can be disposed on the pistons to retain fluid within the pistons, and such film is configured to dissolve when the temperature exceeds a threshold temperature associated with a thermal runaway event or fire, thereby allowing fluid to exit from the pistons to suppress the fire.

In another example embodiment, a material such as a polymeric material may cover components of the battery modules (e.g., the pressure distribution plates). In this example embodiment, such material may be configured to melt and suppress any fire within the battery module if the temperature exceeds a threshold temperature.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Implementations of the present disclosure can thus relate to one of the enumerated example implementation (EEEs) listed below.
EEE 1 is a thermal control system for a battery having a plurality of battery modules, the thermal control system comprising: a coolant supply system configured to supply hot coolant and cold coolant; a thermal management control module configured to set a target temperature for each battery module of the battery; and a plurality of temperature control units, each temperature control unit configured to control a temperature of a respective battery module independently from other battery modules of the battery, wherein a temperature control unit of the plurality of temperature control units comprises (i) one or more valves, and (ii) a valve control unit configured to control actuation of the one or more valves based on an actual temperature and the target temperature of the respective battery module, wherein the one or more valves are configured to control flow of the hot coolant and the cold coolant received from the coolant supply system, and wherein the temperature control unit is configured to supply a mixture of the hot coolant and the cold coolant to the respective battery module to achieve the target temperature.
EEE 2 is the thermal control system of EEE 1, wherein the coolant supply system comprises: a coolant reservoir configured to store coolant therein; a heating element configured to heat the coolant and provide the hot coolant; a cooling element configured to reduce a temperature of the coolant and provide the cold coolant; and at least one pump configured to draw the coolant from the coolant reservoir and provide the coolant to the heating element and the cooling element.
EEE 3 is the thermal control system of EEE 2, wherein the at least one pump comprises: a first pump configured to draw the coolant from the coolant reservoir and provide the coolant to the heating element; and a second pump configured to draw the coolant from the coolant reservoir and provide the coolant to the cooling element.
EEE 4 is the thermal control system of EEE 3, wherein the coolant supply system further comprises: a bypass valve disposed in a reservoir return line configured to receive coolant discharged from the respective battery module, wherein the bypass valve is configured to provide coolant from the reservoir return line to the first pump, such that at least a portion of coolant in the reservoir return line is provided to the heating element.
EEE 5 is the thermal control system of any of EEEs 1-4, wherein the one or more valves of the temperature control unit comprise: a hot coolant control valve configured to control flow of the hot coolant received from the coolant supply system; and a cold coolant control valve configured to control flow of the cold coolant received from the coolant supply system, wherein the hot coolant control valve and the cold coolant control valve are actuatable by the valve control unit based on a difference between the target temperature and the actual temperature of the respective battery module.
EEE 6 is the thermal control system of EEE 5, wherein the temperature control unit further comprises: a bypass valve configured to relieve coolant provided to the hot coolant control valve or coolant provided to the cold coolant control valve to a return line when pressure level of the coolant exceeds a threshold pressure value.
EEE 7 is the thermal control system of any of EEEs 5-6, wherein the temperature control unit further comprises: a mixing reservoir configured to receive the hot coolant from the hot coolant control valve and the cold coolant from the cold coolant control valve, thereby allowing the hot coolant and the cold coolant to mix in the mixing reservoir before providing the mixture of the hot coolant and the cold coolant to the respective battery module.
EEE 8 is the thermal control system of an of EEEs 1-7, further comprising: a diagnostic module disposed between the temperature control unit and the respective battery module, wherein the diagnostic module comprises a plurality of sensors configured to measure one or more properties of the mixture provided to the respective battery module and coolant discharged from the respective battery module, wherein the one or more properties comprise: pressure of coolant, flow rate of coolant, or temperature of coolant.
EEE 9 is a pressure control system comprising: a battery having a plurality of battery modules, each battery module comprising a plurality of battery cells; a fluid supply system; a pressure management control module configured to set a target pressure to be applied to respective battery cells of each battery module of the battery via fluid from the fluid supply system; and a plurality of pressure control units, each pressure control unit configured to control pressure applied to the respective battery cells of a respective battery module independently from other battery modules of the battery, wherein a pressure control unit of the plurality of pressure control units comprises (i) a pressure control valve, and (ii) a valve control unit configured to control actuation of the pressure control valve to provide fluid having a target fluid pressure that achieves the target pressure to be applied to the respective battery cells.
EEE 10 is the pressure control system of EEE 9, wherein the fluid supply system comprises: a liquid reservoir configured to store fluid therein; a filter; and a pump configured to draw fluid from the liquid reservoir through the filter and provide the fluid to the pressure control unit.
EEE 11 is the pressure control system of EEE 9, wherein the fluid supply system comprises: an air tank configured to store air therein; a filter; and an air compressor configured to draw fluid from the air tank through the filter, compress the air, and provide pressurized air to the pressure control unit.
EEE 12 is the pressure control system of any of EEEs 9-11, wherein the pressure control unit further comprises: a pressure gauge configured to provide sensor information indicative of an actual pressure of fluid supplied from the pressure control unit to the respective battery module, wherein the valve control unit is configured to: determine the target fluid pressure that achieves the target pressure to be applied to the respective battery cells; compare the target fluid pressure to the actual pressure of fluid; and actuate the pressure control valve to achieve the target fluid pressure.
EEE 13 is the pressure control system of any of EEEs 9-12, wherein the respective battery module comprises: a plurality of pressure distribution plates, each pressure distribution plate interfacing with a respective battery cell; a plurality of pistons, each piston configured to apply pressure to a respective pressure distribution plate of the plurality of pressure distribution plates; and respective fluid lines providing fluid received from the pressure control unit to a respective piston of plurality of pistons, such that the respective piston applies pressure to the respective pressure distribution plate, which in turn applies pressure to the respective battery cell.
EEE 14 is the pressure control system of EEE 13, wherein each fluid line of the respective fluid lines has fluid at a pressure level different from respective pressure levels of fluid in other fluid lines.
EEE 15 is the pressure control system of any of EEEs 9-14, wherein the respective battery module comprises: a cells holder configured to retain the respective battery cells within the respective battery module; at least one pressure distribution plate interfacing with a battery cell of the respective battery cells, such that the respective battery cells are interposed between a side of the cells holder and the at least one pressure distribution plate; a piston configured to apply pressure to the at least one pressure distribution plate; and a fluid line providing fluid received from the pressure control unit to the piston, such that the piston applies pressure to the at least one pressure distribution plate, which in turn applies pressure to the respective battery cells against the side of the cells holder.
EEE 16 is the pressure control system of EEE 15, wherein the at least one pressure distribution plate comprises respective pressure distribution plates interposed between the respective battery cells.
EEE 17 is a vehicle comprising: the thermal control system of any of EEEs 1-8 and the pressure control system of any of EEEs 9-16, wherein the vehicle comprises a fluid supply system that provides coolant to the thermal control system and fluid to the pressure control system.
EEE 18 is the vehicle of EEE 17, wherein the respective battery module comprises: at least one pressure distribution plate interfacing with a respective battery cell; at least one piston configured to apply pressure to the at least one pressure distribution plate; and at least one fluid line providing fluid received from the pressure control unit to the at least one piston, such that the at least one piston applies pressure to the at least one pressure distribution plate, which in turn applies pressure to the respective battery cell, wherein the at least one pressure distribution plate comprises at least one channel formed therein, wherein the mixture of the hot coolant and the cold coolant flows through the at least one channel to transfer heat to, or absorb heat from, the respective battery cell and achieve the target temperature.
EEE 19 is the vehicle of any of EEEs 17-18, wherein the pressure control unit further comprises: a pressure gauge configured to provide sensor information indicative of an actual pressure of fluid supplied from the pressure control unit to the respective battery module, wherein the first valve control unit is configured to: determine the target fluid pressure that achieves the target pressure to be applied to the respective battery cells; compare the target fluid pressure to the actual pressure of fluid; and actuate the pressure control valve to achieve the target fluid pressure.
EEE 20 is the vehicle of any of EEEs 17-19, wherein the one or more valves of the temperature control unit comprise: a hot coolant control valve configured to control flow of the hot coolant received from the fluid supply system; and a cold coolant control valve configured to control flow of the cold coolant received from the fluid supply system, wherein the second valve control unit is configured to: compare the target temperature and the actual temperature of the respective battery module, and based on a difference between the target temperature and the actual temperature, actuate the hot coolant control valve and the cold coolant control valve to provide the mixture of the hot coolant and the cold coolant to the respective battery module to reduce the difference.

What is claimed is:

1. A thermal control system for a battery having a plurality of battery modules, the thermal control system comprising:
a coolant supply system configured to supply hot coolant and cold coolant;
a thermal management control module configured to set a target temperature for each battery module of the battery; and
a plurality of temperature control units, each temperature control unit configured to control a temperature of a respective battery module independently from other battery modules of the battery, wherein a temperature control unit of the plurality of temperature control units comprises (i) one or more valves, and (ii) a valve control unit configured to control actuation of the one or more valves based on an actual temperature and the target temperature of the respective battery module,
wherein the one or more valves are configured to control flow of the hot coolant and the cold coolant received from the coolant supply system, and wherein the temperature control unit is configured to supply a mixture of the hot coolant and the cold coolant to the respective battery module to achieve the target temperature.

2. The thermal control system of claim 1, wherein the coolant supply system comprises:
a coolant reservoir configured to store coolant therein;
a heating element configured to heat the coolant and provide the hot coolant;
a cooling element configured to reduce a temperature of the coolant and provide the cold coolant; and
at least one pump configured to draw the coolant from the coolant reservoir and provide the coolant to the heating element and the cooling element.

3. The thermal control system of claim 2, wherein the at least one pump comprises:
a first pump configured to draw the coolant from the coolant reservoir and provide the coolant to the heating element; and
a second pump configured to draw the coolant from the coolant reservoir and provide the coolant to the cooling element.

4. The thermal control system of claim 3, wherein the coolant supply system further comprises:
a bypass valve disposed in a reservoir return line configured to receive coolant discharged from the respective battery module, wherein the bypass valve is configured to provide coolant from the reservoir return line to the first pump, such that at least a portion of coolant in the reservoir return line is provided to the heating element.

5. The thermal control system of claim 1, wherein the one or more valves of the temperature control unit comprise:
a hot coolant control valve configured to control flow of the hot coolant received from the coolant supply system; and
a cold coolant control valve configured to control flow of the cold coolant received from the coolant supply system, wherein the hot coolant control valve and the cold coolant control valve are actuatable by the valve control unit based on a difference between the target temperature and the actual temperature of the respective battery module.

6. The thermal control system of claim 5, wherein the temperature control unit further comprises:
a bypass valve configured to relieve coolant provided to the hot coolant control valve or coolant provided to the cold coolant control valve to a return line when pressure level of the coolant exceeds a threshold pressure value.

7. The thermal control system of claim 5, wherein the temperature control unit further comprises:
a mixing reservoir configured to receive the hot coolant from the hot coolant control valve and the cold coolant from the cold coolant control valve, thereby allowing the hot coolant and the cold coolant to mix in the mixing reservoir before providing the mixture of the hot coolant and the cold coolant to the respective battery module.

8. The thermal control system of claim 1, further comprising:
a diagnostic module disposed between the temperature control unit and the respective battery module, wherein the diagnostic module comprises a plurality of sensors configured to measure one or more properties of the mixture provided to the respective battery module and coolant discharged from the respective battery module, wherein the one or more properties comprise: pressure of coolant, flow rate of coolant, or temperature of coolant.

9. A pressure control system comprising:
a battery having a plurality of battery modules, each battery module comprising a plurality of battery cells;
a fluid supply system;
a pressure management control module configured to set a target pressure to be applied to respective battery cells of each battery module of the battery via fluid from the fluid supply system; and
a plurality of pressure control units, each pressure control unit configured to control pressure applied to the respective battery cells of a respective battery module independently from other battery modules of the battery, wherein a pressure control unit of the plurality of pressure control units comprises (i) a pressure control valve, and (ii) a valve control unit configured to control actuation of the pressure control valve to provide fluid having a target fluid pressure that achieves the target pressure to be applied to the respective battery cells.

10. The pressure control system of claim 9, wherein the fluid supply system comprises:
a liquid reservoir configured to store fluid therein;
a filter; and
a pump configured to draw fluid from the liquid reservoir through the filter and provide the fluid to the pressure control unit.

11. The pressure control system of claim 9, wherein the fluid supply system comprises:
an air tank configured to store air therein;
a filter; and
an air compressor configured to draw fluid from the air tank through the filter, compress the air, and provide pressurized air to the pressure control unit.

12. The pressure control system of claim 9, wherein the pressure control unit further comprises:
a pressure gauge configured to provide sensor information indicative of an actual pressure of fluid supplied from the pressure control unit to the respective battery module, wherein the valve control unit is configured to:
determine the target fluid pressure that achieves the target pressure to be applied to the respective battery cells;
compare the target fluid pressure to the actual pressure of fluid; and
actuate the pressure control valve to achieve the target fluid pressure.

13. The pressure control system of claim 9, wherein the respective battery module comprises:
a plurality of pressure distribution plates, each pressure distribution plate interfacing with a respective battery cell;
a plurality of pistons, each piston configured to apply pressure to a respective pressure distribution plate of the plurality of pressure distribution plates; and
respective fluid lines providing fluid received from the pressure control unit to a respective piston of plurality of pistons, such that the respective piston applies pressure to the respective pressure distribution plate, which in turn applies pressure to the respective battery cell.

14. The pressure control system of claim 13, wherein each fluid line of the respective fluid lines has fluid at a pressure level different from respective pressure levels of fluid in other fluid lines.

15. The pressure control system of claim 9, wherein the respective battery module comprises:
a cells holder configured to retain the respective battery cells within the respective battery module;
at least one pressure distribution plate interfacing with a battery cell of the respective battery cells, such that the respective battery cells are interposed between a side of the cells holder and the at least one pressure distribution plate;
a piston configured to apply pressure to the at least one pressure distribution plate; and
a fluid line providing fluid received from the pressure control unit to the piston, such that the piston applies pressure to the at least one pressure distribution plate, which in turn applies pressure to the respective battery cells against the side of the cells holder.

16. The pressure control system of claim 15, wherein the at least one pressure distribution plate comprises respective pressure distribution plates interposed between the respective battery cells.

17. A vehicle comprising:
a battery having a plurality of battery modules, each battery module comprising a plurality of battery cells;
a fluid supply system;
a pressure control system comprising: (i) a pressure management control module configured to set a target pressure to be applied to respective battery cells of each battery module of the battery via fluid from the fluid supply system, and (ii) a plurality of pressure control units, each pressure control unit configured to control pressure applied to the respective battery cells of a respective battery module independently from other battery modules of the battery, wherein a pressure control unit of the plurality of pressure control units comprises a pressure control valve, and a first valve control unit configured to control actuation of the pressure control valve to provide fluid having a target fluid pressure that achieves the target pressure to be applied to the respective battery cells; and
a thermal control system comprising: (i) a thermal management control module configured to set a target temperature for each battery module of the battery, and (ii) a plurality of temperature control units, each temperature control unit configured to control a temperature of the respective battery module independently from other battery modules of the battery, wherein a temperature control unit of the plurality of temperature control units comprises one or more valves, and a second valve control unit configured to control actuation of the one or more valves based on an actual temperature and the target temperature of the respective battery module, wherein the one or more valves are configured to control flow of hot coolant and cold coolant received from the fluid supply system, and wherein the temperature control unit is configured to supply a mixture of the hot coolant and the cold coolant to the respective battery module to achieve the target temperature.

18. The vehicle of claim 17, wherein the respective battery module comprises:
at least one pressure distribution plate interfacing with a respective battery cell;
at least one piston configured to apply pressure to the at least one pressure distribution plate; and
at least one fluid line providing fluid received from the pressure control unit to the at least one piston, such that the at least one piston applies pressure to the at least one pressure distribution plate, which in turn applies pressure to the respective battery cell,
wherein the at least one pressure distribution plate comprises at least one channel formed therein, wherein the mixture of the hot coolant and the cold coolant flows through the at least one channel to transfer heat to, or absorb heat from, the respective battery cell and achieve the target temperature.

19. The vehicle of claim 17, wherein the pressure control unit further comprises:
a pressure gauge configured to provide sensor information indicative of an actual pressure of fluid supplied from the pressure control unit to the respective battery module, wherein the first valve control unit is configured to:
determine the target fluid pressure that achieves the target pressure to be applied to the respective battery cells;
compare the target fluid pressure to the actual pressure of fluid; and
actuate the pressure control valve to achieve the target fluid pressure.

20. The vehicle of claim 17, wherein the one or more valves of the temperature control unit comprise:
a hot coolant control valve configured to control flow of the hot coolant received from the fluid supply system; and
a cold coolant control valve configured to control flow of the cold coolant received from the fluid supply system, wherein the second valve control unit is configured to:
compare the target temperature and the actual temperature of the respective battery module, and
based on a difference between the target temperature and the actual temperature, actuate the hot coolant control valve and the cold coolant control valve to provide the mixture of the hot coolant and the cold coolant to the respective battery module to reduce the difference.
